(19) United States
(12) Patent Application Publication
(10) Pub. No.: US 2025/0324007 A1
(43) Pub. Date: Oct. 16, 2025

(54) IMAGE FORMING APPARATUS, INFORMATION PROCESSING METHOD, AND STORAGE MEDIUM

(71) Applicant: Yoshiharu TAKAHASHI, Kanagawa (JP)

(72) Inventor: Yoshiharu TAKAHASHI, Kanagawa (JP)

(21) Appl. No.: 19/173,841

(22) Filed: Apr. 9, 2025

(30) Foreign Application Priority Data
Apr. 10, 2024 (JP) 2024-063149
Dec. 24, 2024 (JP) 2024-227554

(51) Int. Cl. H04N 1/00

(52) U.S. Cl. CPC H04N 1/00769; H04N 1/00702; H04N 1/00716; H04N 1/00766; H04N 2201/0094

(57) ABSTRACT

An image forming apparatus includes a conveyance mechanism, a sheet sensor, a sheet thickness sensor, and circuitry. The conveyance mechanism conveys a sheet. The sheet sensor detects the sheet conveyed by the conveyance mechanism at a predetermined position on a conveyance path. The sheet thickness sensor detects sheet thickness information indicating a thickness of the sheet. The circuitry acquires conveyance time information indicating a conveyance time taken to convey the sheet in a predetermined section on the conveyance path, according to a detection result of the sheet by the sheet sensor. The circuitry stores the conveyance time information for each thickness of the sheet in a storage medium, and predicts a failure timing of the conveyance mechanism at the predetermined position for each thickness of the sheet, based on the conveyance time information stored in the storage medium and an accumulative number of sheets conveyed by the conveyance mechanism.

### CROSS-REFERENCE TO RELATED APPLICATIONS

This patent application is based on and claims priority pursuant to 35 U.S.C. § 119(a) to Japanese Patent Application Nos. 2024-063149, filed on Apr. 10, 2024, and 2024-227554, filed on Dec. 24, 2024, in the Japan Patent Office, the entire disclosure of each of which is hereby incorporated by reference herein.

### BACKGROUND

### Technical Field

The present disclosure relates to an image forming apparatus, an information processing method, and a storage medium.

### Related Art

In recent years, in a multifunction peripheral that can be used as a printer, a facsimile, a scanner, or a copier, a technique has been used that recognizes deterioration over time of a mechanism that conveys a sheet and performing failure prediction at the time of conveying a sheet for image formation output.

### SUMMARY

The present disclosure described herein provides an image forming apparatus that includes a conveyance mechanism, a sheet sensor, a sheet thickness sensor, and circuitry. The conveyance mechanism conveys a sheet. The sheet sensor detects the sheet conveyed by the conveyance mechanism at a predetermined position on a conveyance path. The sheet thickness sensor detects sheet thickness information indicating a thickness of the sheet. The circuitry acquires conveyance time information indicating a conveyance time taken to convey the sheet in a predetermined section on the conveyance path, according to a detection result of the sheet by the sheet sensor. The circuitry stores the conveyance time information for each thickness of the sheet in a storage medium, and predicts a failure timing of the conveyance mechanism at the predetermined position for each thickness of the sheet, based on the conveyance time information stored in the storage medium and an accumulative number of sheets conveyed by the conveyance mechanism.

The present disclosure described herein also provides an information processing method that includes: detecting a sheet conveyed by a conveyance mechanism at a predetermined position on a conveyance path; acquiring conveyance time information indicating a conveyance time taken to convey the sheet in a predetermined section on the conveyance path, according to a result of detecting the sheet; detecting sheet thickness information indicating a thickness of the sheet; storing the conveyance time information for each thickness of the sheet; and predicting a failure timing of the conveyance mechanism at the predetermined position for each thickness of the sheet, based on the conveyance time information stored by the storing and an accumulative number of conveyed sheets.

The present disclosure described herein further provides a non-transitory storage medium storing program code which, when one or more processors are executed, causes the processors to execute: detecting a sheet conveyed by a conveyance mechanism at a predetermined position on a conveyance path; acquiring conveyance time information indicating a conveyance time taken to convey the sheet in a predetermined section on the conveyance path according to a result of detecting the sheet; detecting sheet thickness information indicating a thickness of the sheet; storing the conveyance time information for each thickness of the sheet; and predicting a failure timing of the conveyance mechanism at the predetermined position for each thickness of the sheet, based on the conveyance time information stored by the storing and an accumulative number of conveyed sheets.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a hardware configuration of an image forming apparatus according to a first embodiment;

FIG. 2 is a block diagram illustrating a functional configuration of the image forming apparatus according to the first embodiment;

FIG. 3 is a diagram schematically illustrating a sheet feeding table, a print engine, a sheet ejection tray, and a sheet conveyance path through these parts according to the first embodiment;

FIG. 4 is a diagram illustrating an example of a functional configuration of an engine control unit according to the first embodiment;

FIG. 5 is a diagram illustrating an example of information stored in a timing threshold storage unit;

FIG. 6 is a timing chart illustrating an operation state of a sheet conveyance mechanism and a detection state of a timing sensor in a normal operation of the image forming apparatus;

FIG. 7 is a diagram illustrating an example of conveyance time information stored in a detected information storage unit;

FIG. 8 is a graph illustrating an example of a failure timing predicted for each sheet thickness;

FIG. 9A is a flowchart illustrating an example of processing according to the first embodiment;

FIG. 9B is a flowchart illustrating an example of failure timing prediction processing according to the first embodiment;

FIG. 10 is a diagram illustrating an example of a prediction result of a failure timing;

FIG. 11 is a block diagram illustrating a functional configuration of an image forming apparatus according to a second embodiment;

FIG. 12 is a diagram illustrating an example of a functional configuration of an engine control unit according to the second embodiment;

FIG. 13 is a diagram illustrating an example of information stored in a detected information storage unit;

FIG. 14 is a graph illustrating an example of a decrease in prediction accuracy in a case where a conveyance time suddenly increases;

FIG. 15 is a graph illustrating an example of a decrease in prediction accuracy in a case where a conveyance time suddenly decreases;

FIG. 16 is a flowchart illustrating an example of failure timing prediction processing according to a third embodiment;

FIG. 17 is a diagram schematically illustrating a sheet feeding table, a print engine, a sheet ejection tray, and a sheet conveyance path through these parts according to a fourth embodiment;

FIG. 18 is a flowchart illustrating an example of a functional configuration of an engine control unit according to the fourth embodiment;

FIG. 19 is a flowchart illustrating an example of failure timing prediction processing according to the fourth embodiment; and

FIG. 20 is a diagram schematically illustrating a functional configuration of prediction processing using a learned model.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of an image forming apparatus, an information processing method, and a program will be described in detail with reference to the accompanying drawings.

### First Embodiment

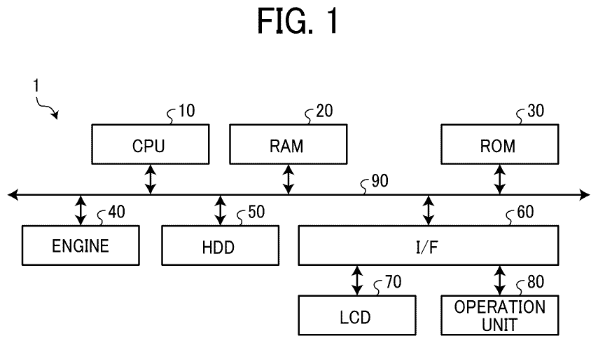

FIG. 1 is a block diagram illustrating a hardware configuration of an image forming apparatus 1 according to the present embodiment. As illustrated in FIG. 1, the image forming apparatus 1 according to the present embodiment includes an engine that executes image formation in addition to the same configuration as an information processing terminal such as a general server or a personal computer (PC). That is, in the image forming apparatus 1 according to the present embodiment, a central processing unit (CPU) 10, a random access memory (RAM) 20, a read only memory (ROM) 30, an engine 40, a hard disk drive (HDD) 50, and an interface (I/F) 60 are connected via a bus 90. Further, a liquid crystal display (LCD) 70 and an operation unit 80 are connected to the I/F 60.

The CPU 10 is a calculator or computing device that controls an overall operation of the image forming apparatus 1. The RAM 20 is a volatile storage medium that allows data to be read and written at high speed. The CPU 10 uses the RAM 20 as a work area for data processing. The ROM 30 is a non-volatile read only storage medium and stores programs, such as firmware. The engine 40 is a mechanism that actually executes image formation in the image forming apparatus 1.

The HDD 50 is a non-volatile storage medium capable of reading and writing information and stores an operating system (OS), various control programs, application programs, and the like. The I/F 60 connects the bus 90 to various hardware components, a network, and the like. The LCD 70 is a visual user interface for the user to confirm the state of the image forming apparatus 1. The operation unit 80 is a user interface, such as a keyboard and a mouse, for inputting information to the image forming apparatus 1 by the user.

In such a hardware configuration, a program stored in a storage medium such as the ROM 30, the HDD 50, or an optical disk is read into the RAM 20, and operates under the control of the CPU 10, thereby configuring a software control unit. A combination of the software control unit configured as described above and the hardware configures a functional block that implements functions of the image forming apparatus 1 according to the present embodiment.

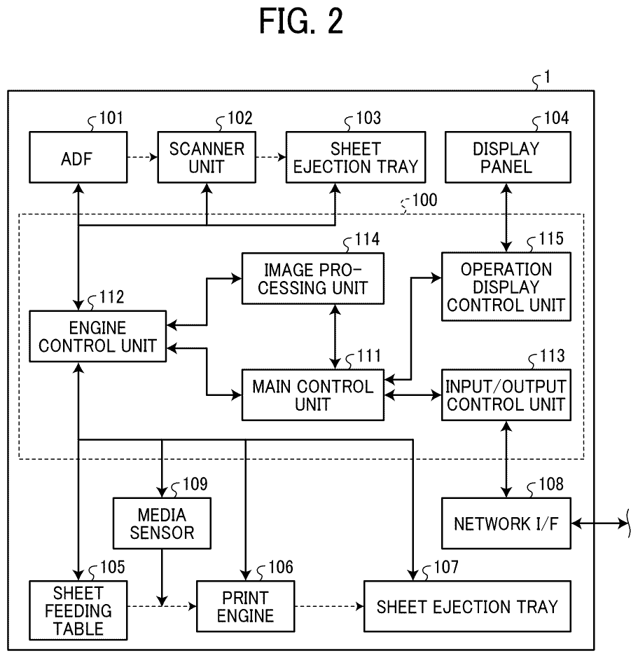

Next, a functional configuration of the image forming apparatus 1 according to the present embodiment will be described referring to FIG. 2. FIG. 2 is a block diagram illustrating a functional configuration of the image forming apparatus 1 according to the present embodiment. As illustrated in FIG. 2, the image forming apparatus 1 according to the present embodiment includes a controller 100, an auto document feeder (ADF) 101, a scanner unit 102, a sheet ejection tray 103, a display panel 104, a sheet feeding table 105, a print engine 106, a sheet ejection tray 107, a network I/F 108, and a media sensor 109.

In addition, the controller 100 includes a main control unit 111, an engine control unit 112, an input/output control unit 113, an image processing unit 114, and an operation display control unit 115. As illustrated in FIG. 2, the image forming apparatus 1 according to the present embodiment is configured as a multifunction peripheral including the scanner unit 102 and the print engine 106. In FIG. 2, an electrical connection is illustrated by a solid arrow, and a flow of a sheet is illustrated by a broken arrow.

The display panel 104 is an output interface that visually displays the state of the image forming apparatus 1, and is also an input interface (operation unit) when the user directly operates the image forming apparatus 1 as a touch panel or inputs information to the image forming apparatus 1. The network I/F 108 is an interface for the image forming apparatus 1 to communicate with other devices via a network, and Ethernet (registered trademark) or a universal serial bus (USB) interface is used.

The controller 100 is configured by a combination of software and hardware. Specifically, a control program such as firmware stored in a non-volatile storage medium such as the ROM 30, the non-volatile memory, the HDD 50, or an optical disk is loaded into a volatile memory (hereinafter, the memory) such as the RAM 20, and the controller 100 is configured by a software control unit configured under the control of the CPU 10 and hardware such as an integrated circuit. The controller 100 functions as a control unit that controls the entire image forming apparatus 1. The controller 100 is an example of a computer.

The main control unit 111 serves a role of controlling each unit included in the controller 100 and gives a command to each unit of the controller 100. The engine control unit 112 serves as a drive unit that controls or drives the print engine 106, the scanner unit 102, and the like. In addition, as a function according to the gist of the present embodiment, the engine control unit 112 has a function of recognizing deterioration of a conveyance mechanism included in the sheet feeding table 105 and the print engine 106 and predicting a failure timing. Details of the function of the engine control unit 112 will be described later.

The input/output control unit 113 inputs signals and commands input via the network I/F 108 to the main control unit 111. The main control unit 111 controls the input/output control unit 113 to access another device via the network I/F 108.

The image processing unit 114 generates drawing information on the basis of print information included in an input print job under the control of the main control unit 111. The drawing information is information for drawing an image to be formed in an image forming operation by the print engine 106 as an image forming unit. The print information included in a print job is image information converted into a format recognizable by the image forming apparatus 1, by a printer driver installed in an information processing apparatus such as a PC.

The image processing unit 114 processes imaging data input from the scanner unit 102 and generates image data. The image data is information stored in the image forming apparatus 1 as a result of the scanner operation or stored in a file server or the like connected via a network. The operation display control unit 115 displays information on the display panel 104 or notifies the main control unit 111 of information input via the display panel 104.

When the image forming apparatus 1 operates as a printer, first, the input/output control unit 113 receives a print job via the network I/F 108. The input/output control unit 113 transfers the received print job to the main control unit 111. Upon receiving the print job, the main control unit 111 controls the image processing unit 114 to generate drawing information on the basis of the print information included in the print job.

When the drawing information is generated by the image processing unit 114, the engine control unit 112 executes image formation on the sheet conveyed from the sheet feeding table 105 on the basis of the generated drawing information. That is, the print engine 106 functions as an image forming unit. As a specific mode of the print engine 106, an image forming mechanism by an inkjet method, an image forming mechanism by an electrophotographic method, or the like can be used. The document on which the image is formed by the print engine 106 is ejected to the sheet ejection tray 107.

In a case where the image forming apparatus 1 operates as a scanner, the operation display control unit 115 or the input/output control unit 113 transfers a scan execution signal to the main control unit 111 in response to an operation of the display panel 104 by the user or a scan execution instruction input from an external client terminal or the like via the network I/F 108. The main control unit 111 controls the engine control unit 112 on the basis of the received scan execution signal.

The engine control unit 112 drives the ADF 101 to convey a document to be imaged set in the ADF 101 to the scanner unit 102. The engine control unit 112 drives the scanner unit 102 to capture an image of the document conveyed from the ADF 101. In a case where the document is not set in the ADF 101 and the document is directly set in the scanner unit 102, the scanner unit 102 captures an image of the set document under the control of the engine control unit 112. That is, the scanner unit 102 operates as an imaging unit.

In the imaging operation, an imaging element such as a CCD included in the scanner unit 102 optically scans the document, and imaging information generated on the basis of the optical information is generated. The engine control unit 112 transfers the imaging information generated by the scanner unit 102 to the image processing unit 114. The image processing unit 114 generates image information on the basis of the imaging information received from the engine control unit 112 under the control of the main control unit 111. The image information generated by the image processing unit 114 is stored in a storage medium such as the HDD 50 attached to the image forming apparatus 1.

The image information generated by the image processing unit 114 is directly stored in the HDD 50 or the like in response to a user's instruction or transmitted to an external device via the input/output control unit 113 and the network I/F 108. That is, the ADF 101 and the engine control unit 112 function as an image input unit.

When the image forming apparatus 1 operates as a copier, the image processing unit 114 generates drawing information on the basis of imaging information received by the engine control unit 112 from the scanner unit 102 or the image information generated by the image processing unit 114. Similarly to the case of printer operation, the engine control unit 112 drives the print engine 106 on the basis of the drawing information.

The media sensor 109 detects information on a sheet conveyed from the sheet feeding table 105 to the print engine 106 when the image forming apparatus 1 operates as a printer or a copier. Examples of the information that can be detected by the media sensor 109 include the thickness of the sheet, the material of the sheet, the quality of the sheet, and the friction coefficient of the surface of the sheet. The media sensor 109 according to the present embodiment functions as a sheet thickness sensor that detects sheet thickness information indicating the thickness of the sheet. Detection output by the media sensor 109 is input to the engine control unit 112. The control program constituting the controller 100 causes the engine control unit 112 to function as a sheet thickness sensor that detects the sheet thickness information by the media sensor 109.

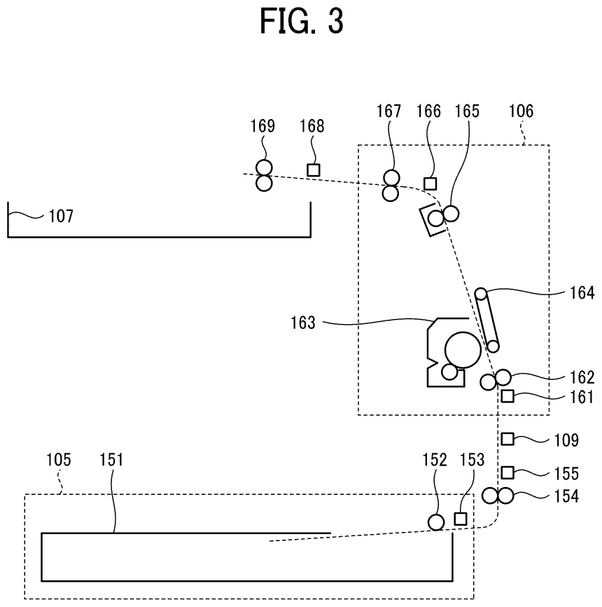

Next, the sheet feeding table 105, the print engine 106, the sheet ejection tray 107, and a sheet conveyance path through these parts according to the present embodiment will be described with reference to FIG. 3. FIG. 3 is a diagram schematically illustrating the sheet feeding table 105, the print engine 106, the sheet ejection tray 107, and the sheet conveyance path through these parts according to the present embodiment. In FIG. 3, a conveyance path on which a sheet is conveyed is indicated by a one-dot chain line.

As illustrated in FIG. 3, the sheet feeding table 105 according to the present embodiment includes a sheet feeding tray 151, a sheet feeding roller 152, and a sheet feeding sensor 153. The sheet feeding tray 151 is a tray on which sheets are stacked. The sheet feeding roller 152 pulls out a sheet stacked on the sheet feeding tray 151 and feeds the sheet to the conveyance path. The sheet feeding sensor 153 is a timing sensor that detects the sheet fed to the conveyance path by the sheet feeding roller 152.

As illustrated in FIG. 3, in addition to the media sensor 109, an intermediate feed roller 154 and an intermediate feed sensor 155 are provided in the conveyance path between the sheet feeding table 105 and the print engine 106 according to the present embodiment. The intermediate feed roller 154 conveys the sheet conveyed from the sheet feeding table 105 to the print engine 106. The intermediate feed sensor 155 is a timing sensor that detects the sheet conveyed by the intermediate feed roller 154.

As illustrated in FIG. 3, the print engine 106 according to the present embodiment includes a registration sensor 161, a registration roller 162, an image forming unit 163, a transfer/separation unit 164, a fixing unit 165, a front sheet ejection sensor 166, and a front sheet ejection roller 167.

The registration sensor 161 is a timing sensor that detects the sheet conveyed into the print engine 106. The registration roller 162 conveys the sheet detected by the registration sensor 161 toward the transfer/separation unit 164. The registration roller 162 conveys the sheet in synchronization with the image forming unit 163. The image forming unit 163 includes a photoreceptor, a charging device, and a developing device, and forms a toner image to be transferred to the conveyed sheet.

The transfer/separation unit 164 transfers the toner image formed in the image forming unit 163 to the conveyed sheet. The fixing unit 165 fixes the toner image transferred onto the sheet. The front sheet ejection sensor 166 is a timing sensor that detects a sheet that has passed through the fixing unit 165. The front sheet ejection roller 167 conveys the sheet detected by the front sheet ejection sensor 166 to the outside of the print engine 106.

As illustrated in FIG. 3, a rear sheet ejection sensor 168 and a rear sheet ejection roller 169 are provided in the conveyance path between the print engine 106 and the sheet ejection tray 107 according to the present embodiment. The rear sheet ejection sensor 168 is a timing sensor that detects a sheet ejected from the print engine 106. The rear sheet ejection roller 169 ejects the sheet detected by the rear sheet ejection sensor 168 to the sheet ejection tray 107.

As described above, the conveyance mechanism of the image forming apparatus 1 according to the present embodiment includes the sheet feeding roller 152, the intermediate feed roller 154, the registration roller 162, the front sheet ejection roller 167, and the rear sheet ejection roller 169. In addition, the timing sensors illustrated in FIG. 3, that is, the sheet feeding sensor 153, the intermediate feed sensor 155, the registration sensor 161, the front sheet ejection sensor 166, and the rear sheet ejection sensor 168 are controlled by the engine control unit 112. Each timing sensor illustrated in FIG. 3 functions as a sheet sensor that detects the sheet conveyed at a predetermined position on the sheet conveyance path. The control program constituting the controller 100 causes the engine control unit 112 to function as a sheet detection unit that detects a sheet by each timing sensor.

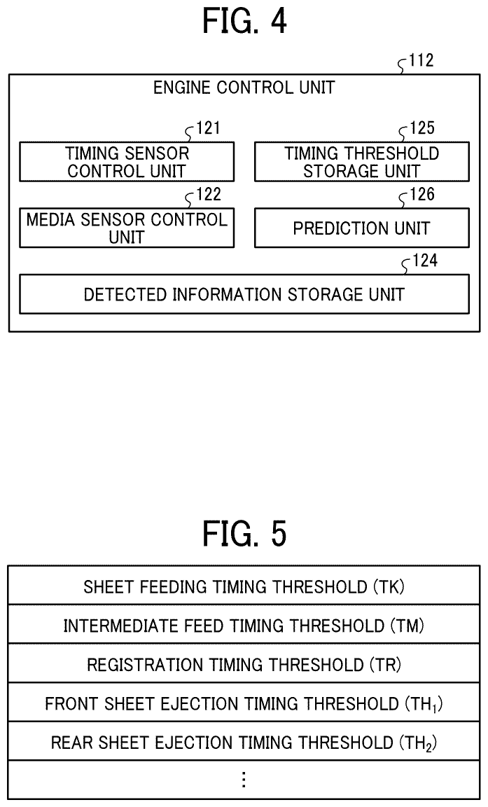

The engine control unit 112 has a function of recognizing the above-described deterioration of the conveyance mechanism and predicting a failure timing of the conveyance mechanism on the basis of outputs of the timing sensors and the media sensor 109 illustrated in FIG. 3 and environmental information of the image forming apparatus 1. Next, a functional configuration of the engine control unit 112 will be described with reference to FIG. 4.

FIG. 4 is a diagram illustrating an example of an overall configuration of the engine control unit 112 according to the present embodiment. As illustrated in FIG. 4, the engine control unit 112 includes a timing sensor control unit 121, a media sensor control unit 122, a detected information storage unit 124, a timing threshold storage unit 125, and a prediction unit 126. The timing sensor control unit 121 controls each of the timing sensors illustrated in FIG. 3 to acquire a detection signal of the sheet by each of the timing sensors, and acquires information of a conveyance time that is a time taken by each conveyance mechanism illustrated in FIG. 3 to convey the sheet in a predetermined section on the conveyance path. That is, the timing sensor control unit 121 functions as a conveyance time information acquisition unit. The control program constituting the controller 100 causes the timing sensor control unit 121 to function as a conveyance time information acquisition unit that acquires information on the conveyance time.

The media sensor control unit 122 controls the media sensor 109 to acquire a detection signal thereof, and acquires information regarding the sheet being conveyed. As described above, since the media sensor 109 according to the present embodiment detects the thickness of the sheet, the media sensor control unit 122 according to the present embodiment acquires information of the thickness of the sheet (hereinafter, the sheet thickness information is used).

The detected information storage unit 124 stores the information acquired by the timing sensor control unit 121 and the media sensor control unit 122 on the basis of the output signal of each sensor in a storage medium such as the HDD 50. The information stored in the detected information storage unit 124 will be described in detail later.

The timing threshold storage unit 125 stores a threshold for predicting the failure timing of the conveyance mechanism with respect to the arrival time of the sheet detected by each timing sensor in a storage medium such as the HDD 50. FIG. 5 is a diagram illustrating an example of information stored in the timing threshold storage unit 125. As illustrated in FIG. 5, the timing threshold storage unit 125 stores information of a sheet feeding timing threshold (TK), an intermediate feed timing threshold (TM), a registration timing threshold (TR), a front sheet ejection timing threshold (TH₁), and a rear sheet ejection timing threshold (TH₂). That is, the above TK, TM, TR, TH₁, and TH₂ are used as prediction thresholds of failure timing. Therefore, the timing threshold storage unit 125 functions as a prediction threshold storage unit.

The sheet feeding timing threshold TK is a reference value for predicting a failure timing for a detection timing by the sheet feeding sensor 153. As illustrated in FIG. 3, since the sheet feeding sensor 153 detects a leading edge of the sheet conveyed by the sheet feeding roller 152, the sheet feeding timing threshold TK is used as a threshold for predicting a failure timing of the sheet feeding roller 152.

The intermediate feed timing threshold TM is a reference value for predicting a failure timing for a detection timing by the intermediate feed sensor 155. As illustrated in FIG. 3, since the intermediate feed sensor 155 detects the leading edge of the sheet conveyed by the intermediate feed roller 154, the intermediate feed timing threshold TM is used as a threshold for predicting a failure timing of the intermediate feed roller 154.

The registration timing threshold TR is a reference value for predicting a failure timing for a detection timing by the registration sensor 161. The front sheet ejection timing threshold TH₁ is a reference value for predicting a failure timing for a detection timing by the front sheet ejection sensor 166. As illustrated in FIG. 3, since the front sheet ejection sensor 166 detects the leading edge of the sheet conveyed by an image forming system from the registration roller 162 to the fixing unit 165, the front sheet ejection timing threshold TH₁ is used as a threshold for predicting a failure timing of the image forming system.

The rear sheet ejection timing threshold TH₂ is a reference value for predicting a failure timing for a detection timing by the rear sheet ejection sensor 168. As illustrated in FIG. 3, since the rear sheet ejection sensor 168 detects the leading edge of the sheet conveyed by the front sheet ejection roller 167, the rear sheet ejection timing threshold TH₂ is used as a threshold for predicting the failure timing of the front sheet ejection roller 167.

The prediction unit 126 predicts a failure timing of the conveyance mechanism of the image forming apparatus 1 on the basis of the information acquired by the timing sensor control unit 121 and the media sensor control unit 122 and stored in the detected information storage unit 124 and the information stored in the timing threshold storage unit 125. The function of the prediction unit 126 will be described in detail later. The control program constituting the controller 100 causes the prediction unit 126 to function as a prediction unit that predicts a failure timing of the conveyance mechanism.

In such an image forming apparatus 1, the gist according to the present embodiment is prediction of a failure timing of the sheet conveyance mechanism by the engine control unit 112. Hereinafter, the operation of the image forming apparatus 1 according to the present embodiment will be described.

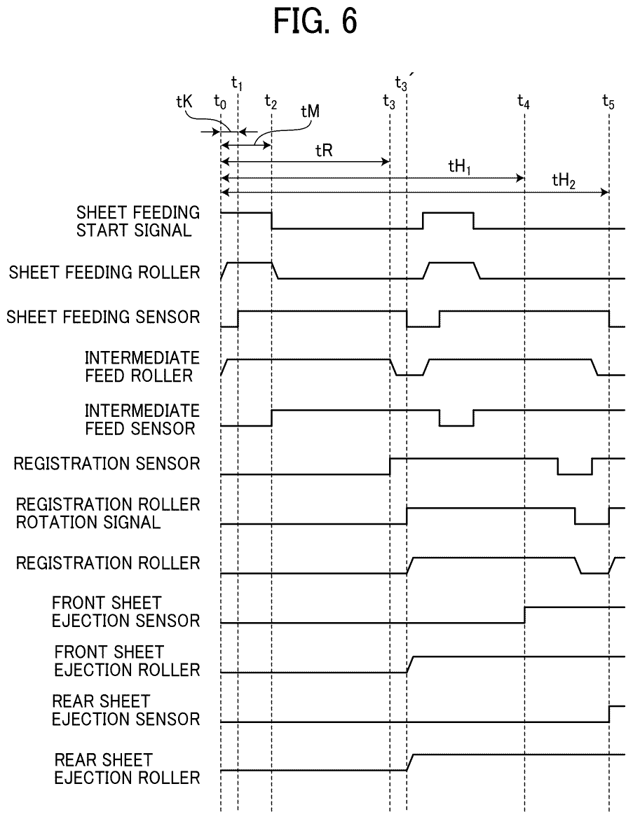

First, an operation state of the sheet conveyance mechanism and a detection state of the timing sensor in the normal operation of the image forming apparatus 1 according to the present embodiment will be described with reference to FIG. 6. FIG. 6 is a timing chart illustrating an operation state of the sheet conveyance mechanism and a detection state of the timing sensor in the normal operation of the image forming apparatus 1 according to the present embodiment.

As illustrated in FIG. 6, first, the sheet feeding roller 152 and the intermediate feed roller 154 start to rotate in response to an output of a sheet feeding start signal by the engine control unit 112 (timing to in the drawing), and the sheets stacked on the sheet feeding tray 151 are separated and conveyed toward the intermediate feed roller 154. In the process, the sheet feeding sensor 153 detects the leading edge of the sheet and switches the output from “0” to “1” (timing t₁ in the drawing). The timing sensor control unit 121 recognizes the timing at which the output of the sheet feeding sensor 153 is switched to “1” from the output timing of the sheet feeding start signal, that is, the period from t₀ to t₁ as a sheet feeding arrival period tK.

The sheet conveyed by the intermediate feed roller 154 is conveyed toward the registration roller 162. In the process, the intermediate feed sensor 155 detects the leading edge of the sheet and switches the output from “0” to “1” (timing t₂ in the drawing). The registration sensor 161 detects the leading edge of the sheet and switches the output from “0” to “1” (timing t₃ in the drawing).

Thus, the timing sensor control unit 121 recognizes the timing at which the output of the intermediate feed sensor 155 is switched to “1” from the output timing of the sheet feeding start signal, that is, the period from t₀ to t₂ as an intermediate feed arrival period tM. The timing sensor control unit 121 recognizes the timing at which the output of the registration sensor 161 is switched to “1” from the output timing of the sheet feeding start signal, that is, the period from t₀ to t₃ as a registration arrival period tR.

Then, the engine control unit 112 stops the rotation of the intermediate feed roller 154 in response to the timing at which the output of the registration sensor 161 is switched to “1”. In the process of the sheet conveyed by the intermediate feed roller 154 reaching the registration roller 162, the media sensor 109 detects the thickness of the sheet. The media sensor control unit 122 acquires the detection output of the media sensor 109 and recognizes the thickness of the sheet being conveyed.

The engine control unit 112 switches a registration roller rotation signal for rotating the registration roller 162 from “0” to “1” in response to the timing at which the output of the registration sensor 161 is switched to “1” (timing t₃′ in the drawing). Thus, the registration roller 162 starts to rotate, and conveys the sheet toward the image forming unit 163 and the transfer/separation unit 164. At the same time as the start of rotation of the registration roller 162, the front sheet ejection roller 167 and the rear sheet ejection roller 169 start to rotate. The sheet on which the toner image has been transferred onto the paper surface by the transfer/separation unit 164 is further conveyed and reaches the fixing unit 165. The toner image transferred onto the paper surface is fixed by the fixing unit 165.

The sheet on which the fixing processing by the fixing unit 165 has been completed is further conveyed and reaches the front sheet ejection roller 167. In the process, the front sheet ejection sensor 166 detects the leading edge of the sheet and switches the output from “0” to “1” (timing t₄ in the drawing). The timing sensor control unit 121 recognizes the timing at which the output of the sheet feeding sensor 153 is switched to “1” from the output timing of the sheet feeding start signal, that is, the period from t₀ to t₄ as a front sheet ejection arrival period tH₁.

The sheet that has reached the front sheet ejection roller 167 is further conveyed by the front sheet ejection roller 167, and reaches the rear sheet ejection roller 169. In the process, the rear sheet ejection sensor 168 detects the leading edge of the sheet and switches the output from “0” to “1” (timing t₅ in the drawing). The timing sensor control unit 121 recognizes the timing at which the output of the sheet feeding sensor 153 is switched to “1” from the output timing of the sheet feeding start signal, that is, the period from t₀ to t₅ as a rear sheet ejection arrival period tH₂. The sheet that has reached the rear sheet ejection roller 169 is ejected to the outside of the apparatus by the rear sheet ejection roller 169, and the conveyance of the sheet in the image forming apparatus 1 is completed.

The periods of tK, tM, tR, tH₁, and tH₂ acquired as described above are the conveyance time taken to convey the sheet at a predetermined position on the conveyance path. Hereinafter, positions in the vicinity of the sheet feeding sensor 153, the intermediate feed sensor 155, the registration sensor 161, the front sheet ejection sensor 166, and the rear sheet ejection sensor 168 on the conveyance path are sequentially referred to as first to fifth positions. Since the conveyance time is a conveyance time corresponding to the m-th position (m=0, 1, . . . , 5), for example, tK is represented by t₀, tM is represented by t₁, . . . , and so on using a symbol tm. Similarly, the timing thresholds TK, TM, TR, TH₁, and TH₂ are represented by symbols Tm (m=0, 1, . . . , 5).

The prediction unit 126 predicts a failure timing (JmK) of the conveyance mechanism at a predetermined position (m-th position) for each thickness of the sheet by using the information of the conveyance time (conveyance time information tm), the predetermined threshold Tm, and the detection result (sheet thickness=K) of the media sensor 109.

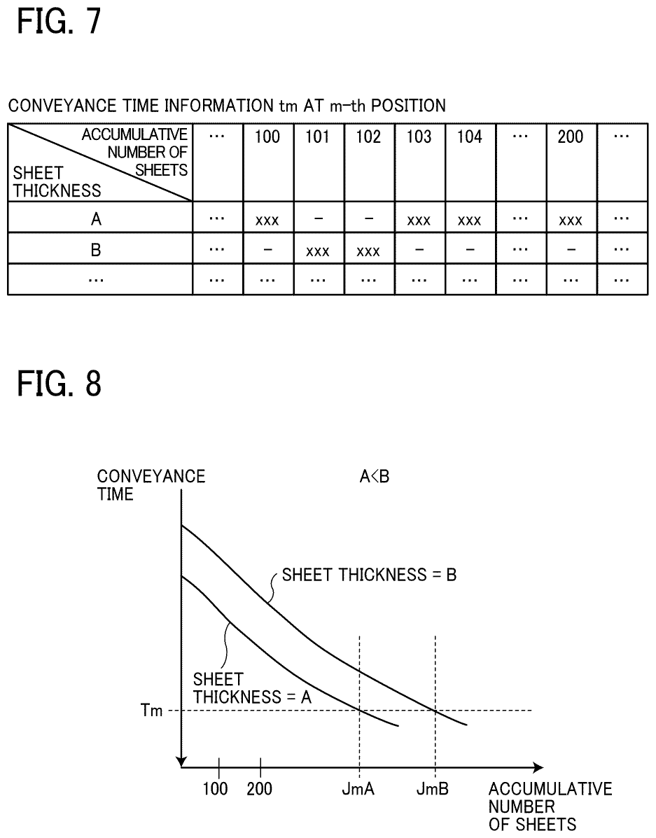

FIG. 7 is a diagram illustrating an example of the conveyance time information stored in the detected information storage unit 124. In FIG. 7, the conveyance time information tm at the m-th position is illustrated in a tabular form. Here, a lateral direction of the table represents the accumulative number of conveyed sheets, and a front vertical direction represents the sheet thickness of the sheet. In addition, “xxx” indicates a value of tm detected and stored, and “-” indicates that tm of the sheet thickness is not detected. In this manner, the sheet thickness information and the conveyance time information tm are stored in association with the information of the accumulative number of sheets. In this example, for a sheet having a sheet thickness of A, tm is detected and stored when the accumulative number of sheets is 100, 103, 104, and 200. In addition, tm is detected and stored when the accumulative number of sheets is 101 or 102 for the sheet having the sheet thickness B. The type of the sheet thickness may be three or more. The control program constituting the controller 100 causes the detected information storage unit 124 to function as a detected information storage that stores the conveyance time information tm for each thickness of the sheet.

FIG. 8 is a graph illustrating an example of a failure timing predicted for each sheet thickness. In FIG. 8, the horizontal axis of the graph represents the accumulative number of conveyed sheets, and the vertical axis represents the conveyance time tm. Here, the vertical axis indicates that the positive direction is a downward direction, and the lower side of the vertical axis indicates that the conveyance time is longer. The two curves are prediction curves of the conveyance time corresponding to the sheet thickness (A or B) of each sheet, and it is predicted that the conveyance time becomes longer (the conveyance mechanism deteriorates) as the accumulative number of sheets increases. A prediction curve is obtained by a known method such as fitting using an actual measurement value of the conveyance time as illustrated in FIG. 7. For example, it can be obtained using linear approximation by a linear function or curve approximation by a quadratic or higher function. In addition, in order to obtain the prediction curve with appropriate accuracy, the number of samples of the measurement value is assumed to be, for example, equal to or more than 50 for each sheet thickness. However, the number of samples may be less than 50 as long as appropriate accuracy can be secured.

In FIG. 8, the accumulative number of sheets (JmA and JmB) at which each prediction curve reaches the timing threshold Tm indicates a predicted value of the failure timing of each sheet thickness (A or B). In this example, it is predicted that a thin sheet in which B is larger than A and the sheet thickness is A will fail at an earlier failure timing than a failure timing of a thick sheet in which the sheet thickness is B (JmA<JmB). This is because the measurement value of the conveyance time varies depending on the sheet thickness. In this manner, since the actual measurement value of the conveyance time is larger for a thin sheet than for a thick sheet, when the predicted value of the failure timing is obtained from data for different sheet thicknesses, the accuracy of the prediction deteriorates due to variation in the actual measurement value. On the other hand, the prediction accuracy can be improved by obtaining the predicted value of the failure timing for each sheet thickness as in the present embodiment.

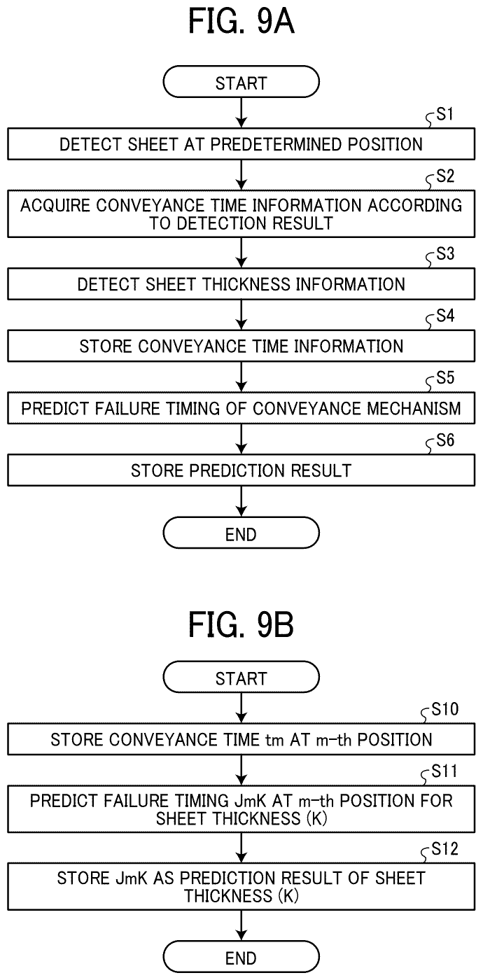

FIG. 9A is a flowchart illustrating an example of processing according to the present embodiment. First, each timing sensor detects a sheet conveyed at a predetermined position on the conveyance path (step S1), and the timing sensor control unit 121 acquires conveyance time information according to the detection result (step S2).

Next, the media sensor 109 detects sheet thickness information indicating the thickness of the sheet (step S3), and the detected information storage unit 124 stores conveyance time information for each sheet thickness (step S4).

Then, the prediction unit 126 predicts a failure timing of the conveyance mechanism (step S5) and stores a prediction result (step S6).

FIG. 9B is a flowchart illustrating an example of failure timing prediction processing according to the present embodiment. This flowchart illustrates details of the processing of steps S4 to S6 of FIG. 9A. Here, the processing when the conveyance time tm of one sheet (the sheet thickness is K) is detected after the number of samples of the actual measurement value is sufficiently accumulated at the m-th position is illustrated.

First, the detected information storage unit 124 stores the conveyance time tm detected at the m-th position by the timing sensor control unit 121 (step S10). Next, the prediction unit 126 predicts the failure timing JmK at the m-th position for the sheet thickness (K) acquired by the media sensor control unit 122 (step S11). Here, the prediction unit 126 obtains the prediction curve as described above from the actual measurement value of the conveyance time of the sheet thickness (K), and sets the accumulative number of sheets for which the predicted conveyance time reaches the timing threshold Tm as the predicted value JmK of the failure timing.

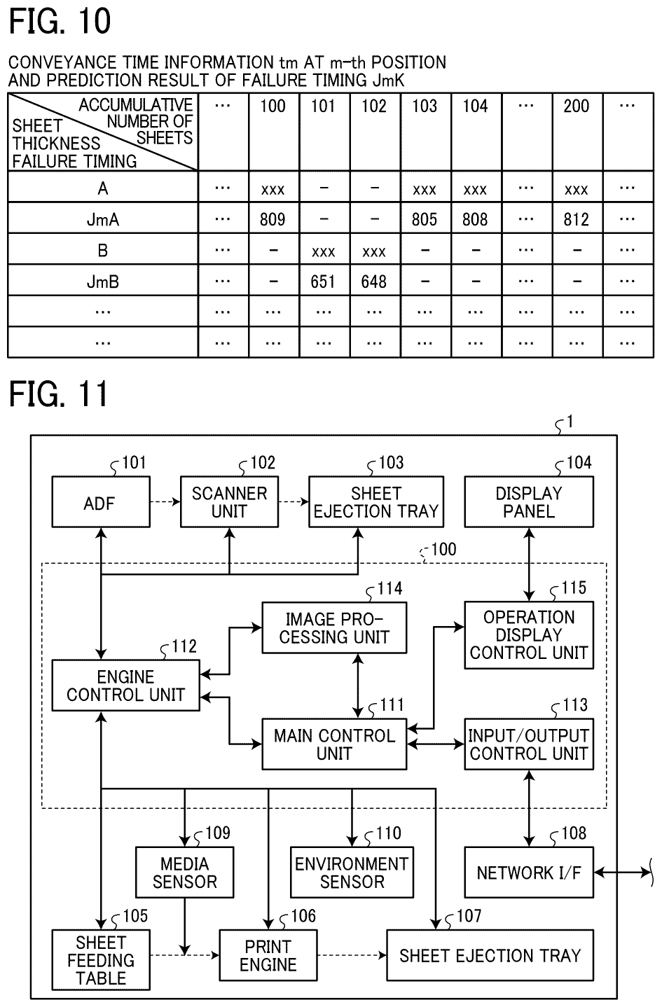

Subsequently, the prediction unit 126 stores the predicted value JmK that is a prediction result in a storage medium such as the HDD 50 (step S12). FIG. 10 is a diagram illustrating an example of a prediction result of a failure timing. Here, the predicted value for the sheet thickness (A) is illustrated in the row of “JmA”, and the predicted value for the sheet thickness (B) is illustrated in the row of “JmB”. In this manner, the prediction unit 126 stores the prediction result of the failure timing at the m-th position for each sheet thickness.

As described above, according to the present embodiment, since the failure timing of the conveyance mechanism at a predetermined position is predicted for each thickness of the sheet, it is possible to perform failure prediction with sufficient prediction accuracy even in a case where data variation due to a difference in sheet thickness is large.

The prediction unit 126 may predict the failure timing for the sheet thickness having no (or not sufficiently accumulated) number of samples of the actual measurement value by using the predicted value of the failure timing obtained for a plurality of sheet thicknesses in which the number of samples of the actual measurement value is sufficiently accumulated. For example, in a case where the number of samples of the measurement value is sufficiently accumulated for the sheet having the sheet thickness A and the sheet thickness B and is not sufficiently accumulated for a sheet having a sheet thickness C, the predicted value JmC of the sheet having the sheet thickness C can be obtained by the following Expression (1) using the predicted value JmA and the predicted value JmB.

$$JmC = ( {α}_{A} \times JmA + {α}_{B} \times JmB ) / ( {α}_{A} + {α}_{B} ) \qquad ( 1 )$$

Here, α_{A} and α_{B} are predetermined coefficients, and are values set in advance by experiments or the like. This coefficient may be set for each sheet thickness, may be dynamically changed according to the usage status of the image forming apparatus 1, or the like. When α_{A}=α_{B}, JmC is obtained by averaging JmA and JmB.

In addition, even in a case where the number of samples of the measurement value is not sufficiently accumulated in the image forming apparatus 1, it is also possible to aggregate data of the measurement value accumulated in another apparatus having the same or similar specification as the image forming apparatus 1 and predict the failure timing. In this case, the prediction unit 126 can predict the failure timing using data of actual values accumulated in another device, which is acquired via the network I/F 108 and stored in the storage medium such as the HDD 50. The prediction unit 126 may predict the failure timing using both the actual measurement value being accumulated in the image forming apparatus 1 and the actual measurement value of another apparatus acquired via the network I/F 108. Thus, since it is possible to predict the failure timing by using an actual measurement value larger than the actual measurement value in the image forming apparatus 1, it is possible to improve the accuracy of prediction.

A description is given below of a second embodiment.

The above-described conveyance time varies depending on a friction coefficient between a sheet conveyed inside the image forming apparatus 1 and a conveyance mechanism that conveys the sheet. In addition, the friction coefficient changes according to environmental conditions (temperature, humidity, and the like) inside the device. In the present embodiment, the parameters (the timing threshold and the detected conveyance time) used for predicting the failure timing of the conveyance mechanism are corrected using information (environmental information) indicating environmental conditions such as temperature and humidity.

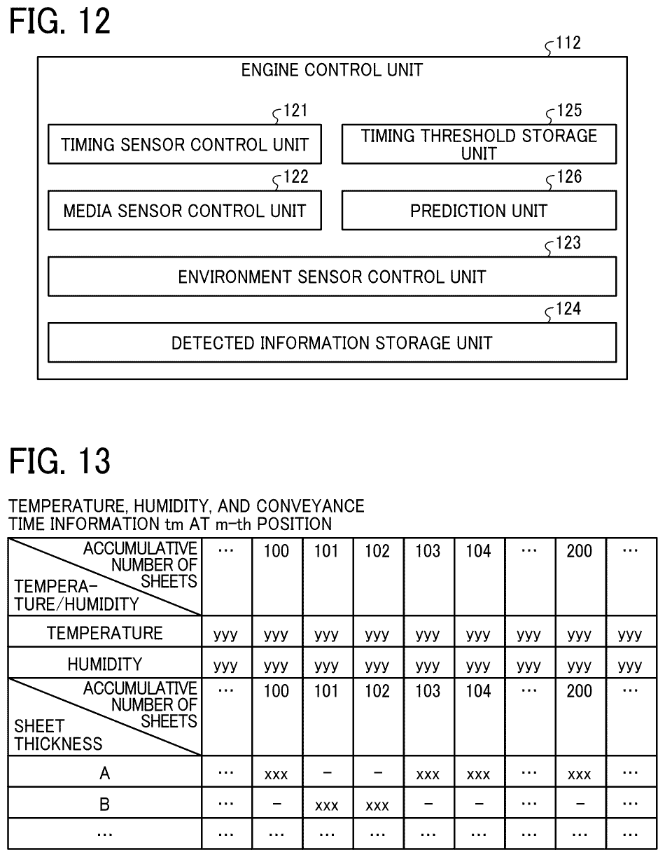

FIG. 11 is a block diagram illustrating a functional configuration of the image forming apparatus 1 according to the present embodiment. FIG. 12 is a diagram illustrating an example of a functional configuration of the engine control unit 112 according to the present embodiment. The difference from the first embodiment is that the image forming apparatus 1 includes the environment sensor 110, the engine control unit 112 includes the environment sensor control unit 123, and the detected information storage unit 124 and the prediction unit 126 perform processing related to environmental information. Other functional configurations and operations are similar to the functional configurations and operations of the first embodiment, and thus detailed description thereof is omitted.

The environment sensor 110 detects temperature, humidity, and the like as conditions of the environment in which the image forming apparatus 1 is operating. That is, the environment sensor 110 functions as a temperature detector, a humidity detector, and the like. Since the environmental conditions detected by the environment sensor 110 are used to obtain the friction coefficient between the sheet and the conveyance mechanism inside the image forming apparatus 1, it is preferable to provide the environmental conditions so that the environmental conditions inside the apparatus can be detected. As long as it is an environmental condition related to friction of the sheet conveyed inside the apparatus, not only temperature and humidity but also other information may be detectable. Further, an environmental condition outside the apparatus may be detected.

The environment sensor control unit 123 controls the environment sensor 110 and acquires a detection signal thereof. As described above, since the environment sensor 110 detects temperature and humidity, the environment sensor control unit 123 according to the present embodiment acquires environmental information inside the image forming apparatus 1.

The environmental information acquired by the environment sensor control unit 123 is used so that conveyance path information is used as information related to the friction coefficient between the sheet being conveyed and the rollers as the conveyance mechanism, and the parameter used for predicting the failure timing can be corrected on the basis of the information related to the friction coefficient. That is, the environmental information described above is used as friction coefficient-related information, and the environment sensor control unit 123 functions as a friction coefficient-related information acquisition unit.

The detected information storage unit 124 stores information acquired by the timing sensor control unit 121, the media sensor control unit 122, and the environment sensor control unit 123 on the basis of output signals of the respective sensors in a storage medium such as the HDD 50.

The prediction unit 126 predicts a failure timing of the conveyance mechanism of the image forming apparatus 1 on the basis of the information acquired by the timing sensor control unit 121, the media sensor control unit 122, and the environment sensor control unit 123 and stored in the detected information storage unit 124 and the information stored in the timing threshold storage unit 125.

FIG. 13 is a diagram illustrating an example of information stored in detected information storage unit 124. In FIG. 13, the temperature, humidity, and conveyance time information tm at the m-th position are illustrated in a table form. “yyy” indicates a value of the detected and stored temperature and humidity. As described above, the environmental information such as temperature and humidity is stored in association with the accumulative number of sheets together with the sheet thickness information and the conveyance time information tm.

The prediction unit 126 corrects the timing threshold Tm by the following Expression (2), and predicts the failure timing using the corrected timing threshold Tm.

$$Tm = Tm + f ( environmental information ) \qquad ( 2 )$$

Here, f is a function for correcting the timing threshold Tm according to the value of the environmental information. Instead of correcting the timing threshold Tm, the prediction unit 126 may correct the detected conveyance time tm by the following Expression (3) and predict the failure timing using the corrected conveyance time tm.

$$tm = tm - f ( environmental information ) \qquad ( 3 )$$

The friction coefficient between the roller and the sheet varies depending on not only deterioration over time such as wear of the roller but also environmental conditions such as temperature and humidity at the time of conveyance. However, when the conveyance speed of the sheet is uniformly determined without considering these conditions, it may be determined that the roller is deteriorated although the roller is not deteriorated so much, or deterioration may not be detected although the roller is deteriorated. On the other hand, the above problem can be solved by correcting the timing threshold Tm in consideration of the environmental conditions at the time of sheet conveyance as in Expressions (2) and (3). For example, the lower the temperature, the lower the friction coefficient of the sheet or the roller tends to be. As a result, the probability of occurrence of slip increases even when the wear of the roller is not progressed. Therefore, the function f included in Expression (2) is set so that the lower the temperature, the higher the value of Tm. That is, f in Expression (2) or (3) is set to a positive value.

In addition, the higher the humidity, the higher the friction coefficient of the sheet or the roller tends to be. As a result, the probability of occurrence of slip decreases even when the wear of the roller progresses. Therefore, the function f included in Expression (2) is set so that the value of Tm decreases as the humidity increases. In other words, f in Expression (2) or (3) has a negative value.

As described above, according to the present embodiment, by correcting the parameter according to the environmental information, it is possible to perform failure prediction with sufficient prediction accuracy for each sheet thickness even when the change in the environmental information is large.

A description is given below of a third embodiment.

In the image forming apparatus 1, there is a case where slip occurs due to adhesion of paper scrap or the like to a sheet, and the conveyance time suddenly increases. In addition, there is a case where the slip is eliminated by “double feeding” in which two or more sheets to be fed overlap with each other, and the conveyance time suddenly decreases. For example, when double feeding suddenly occurs from a state where slip has occurred with thin paper due to deterioration of the conveyance mechanism, the conveyance pressure in the roller increases, and thus the slip decreases. In this case, a behavior as if the deterioration is temporarily recovered appears, but in practice, the conveyance is only stable due to double feeding, and the deterioration is not recovered. For this reason, when the failure timing is predicted using such a detection result, there is a disadvantage that a prediction result that the failure timing is later than the actual failure timing is output. The present embodiment prevents a decrease in the prediction accuracy of the failure timing due to the abnormal value of the conveyance time that suddenly occurs as described above.

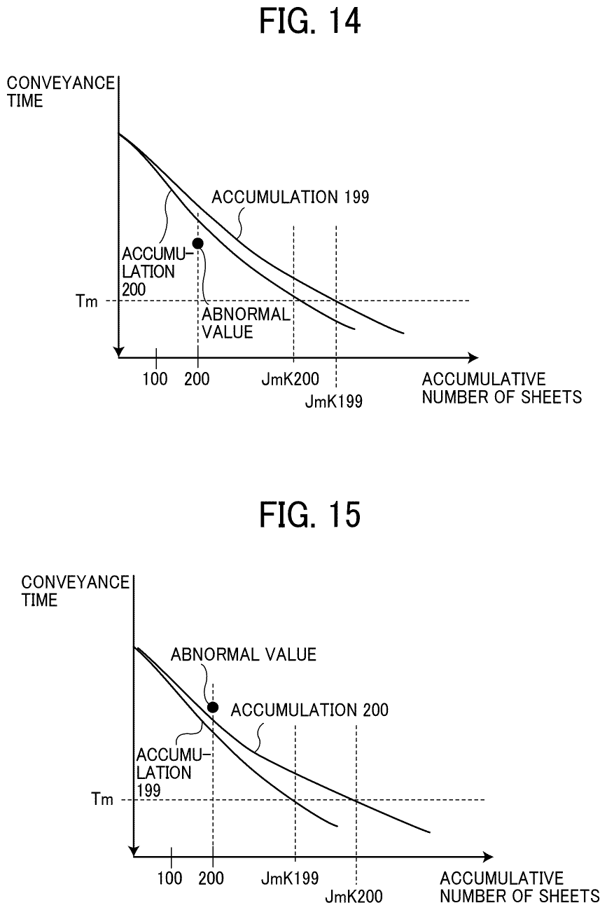

FIG. 14 is a graph illustrating an example of a decrease in prediction accuracy in a case where the conveyance time suddenly increases. In FIG. 14, an accumulation 199 indicates a prediction of the conveyance time for a specific sheet thickness (K) obtained at the time when the accumulative number of sheets is 199, and an accumulation 200 indicates a prediction of the conveyance time obtained when a sheet having the same sheet thickness (K) is conveyed at the time when the accumulative number of sheets is 200. In this example, when the accumulative number of sheets is 200, large conveyance time information indicated by “abnormal value” is detected, and the prediction curve (accumulation 200) obtained including the abnormal value greatly changes from the previous prediction curve (accumulation 199). Therefore, a failure timing JmK200 predicted from the accumulation 200 greatly decreases from a failure timing JmK199 predicted from the accumulation 199, and the prediction accuracy of the failure timing decreases.

FIG. 15 is a graph illustrating an example of a decrease in prediction accuracy in a case where the conveyance time suddenly decreases. In this example, when the accumulative number of sheets is 200, data of a small conveyance time indicated by “abnormal value” is detected, and the prediction curve (accumulation 200) obtained including the abnormal value greatly changes from the previous prediction curve (accumulation 199). Therefore, the failure timing JmK200 predicted from the accumulation 200 greatly increases from the failure timing JmK199 predicted from the accumulation 199, and the prediction accuracy of the failure timing decreases.

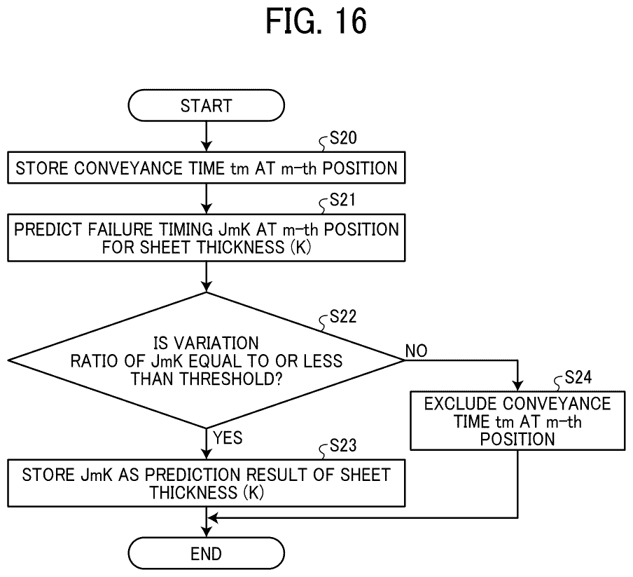

When the predicted value of the failure timing greatly fluctuates as described above, in the present embodiment, the detected latest conveyance time information is regarded as an abnormal value, the failure timing obtained including the abnormal value is not stored as a prediction result (excluded from the prediction result), and the latest conveyance time information is not used for prediction. FIG. 16 is a flowchart illustrating an example of failure timing prediction processing according to the present embodiment. The difference from the first embodiment is that a variation ratio of the failure timing predicted in step S22 is determined, and the conveyance time stored in step S24 is excluded from the storage target when the variation ratio exceeds the threshold. Other functional configurations and operations are similar to the functional configurations and operations of the first embodiment, and thus detailed description thereof is omitted.

The prediction unit 126 monitors the variation of the predicted value JmK of the failure timing for the sheet thickness (K). When the variation ratio of JmK is equal to or less than a predetermined threshold (step S22: Yes), the prediction unit 126 stores the predicted value JmK obtained in step S21 as a prediction result in a storage medium such as the HDD 50 (step S23). On the other hand, when the variation ratio of JmK exceeds the predetermined threshold (step S22: No), the obtained predicted value JmK is not stored as the prediction result (excluded from the prediction result). The prediction unit 126 excludes the latest conveyance time tm stored in step S20 by the detected information storage unit 124 from the storage target, and thus does not use the conveyance time information for subsequent prediction (step S24).

Here, the predetermined threshold is a predetermined ratio for determining whether or not the latest conveyance time is an abnormal value, and can be set to, for example, 10 to 20%. The predetermined ratio is a value set in advance by an experiment or the like. This coefficient may be set for each sheet thickness, may be dynamically changed according to the usage condition of the image forming apparatus 1, or the like.

As described above, according to the present embodiment, the latest conveyance time information is not used for prediction when the variation ratio of the predicted value exceeds the predetermined rate, so that it is possible to prevent a decrease in prediction accuracy of the failure timing due to an abnormal value of the conveyance time to be generated.

A description is given below of a fourth embodiment.

When an abnormal value of the conveyance time occurs due to double feeding of fed sheets, load torque on the rollers increases. In the present embodiment, the load torque on the roller is detected at a predetermined position (m-th position), and the degradation of the prediction accuracy of the failure timing due to the abnormal value is prevented.

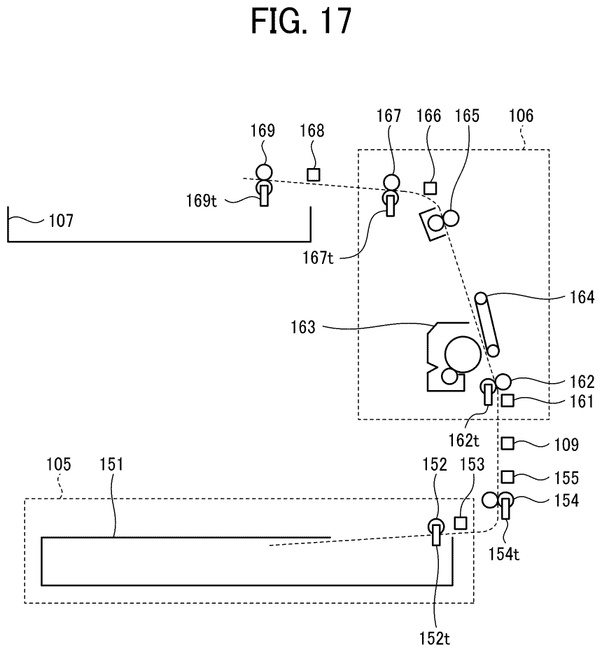

FIG. 17 is a diagram schematically illustrating a sheet feeding table 105, a print engine 106, a sheet ejection tray 107, and a sheet conveyance path through these parts according to the present embodiment. A difference from the first embodiment is that load torque sensors 152t, 154t, 162t, 167t, and 169t that detect load torques applied to the respective rollers are provided in the sheet feeding roller 152, the intermediate feed roller 154, the registration roller 162, the front sheet ejection roller 167, and the rear sheet ejection roller 169, respectively. Here, each load torque sensor functions as a load torque detector that detects a load torque at a predetermined position.

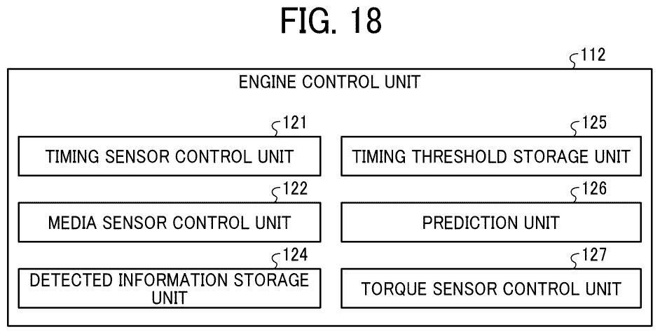

FIG. 18 is a diagram illustrating an example of an overall configuration of an engine control unit 112 according to the present embodiment. The difference from the first embodiment is that the engine control unit 112 includes a torque sensor control unit 127, and a detected information storage unit 124 and a prediction unit 126 perform processing related to the value of the load torque. The torque sensor control unit 127 controls each of the load torque sensors 152t, 154t, 162t, 167t, and 169t, and acquires a detection signal thereof. Other functional configurations and operations are similar to the functional configurations and operations of the first embodiment, and thus detailed description thereof is omitted.

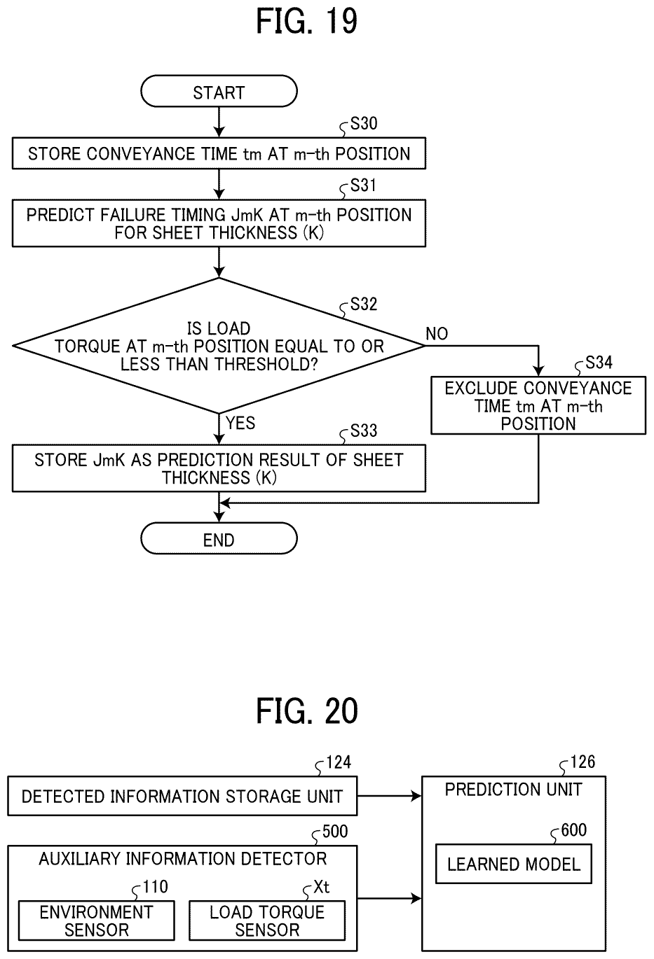

FIG. 19 is a flowchart illustrating an example of failure timing prediction processing according to the present embodiment. The difference from the first embodiment is that the prediction unit 126 monitors the value of the load torque acquired by the torque sensor control unit 127 in step S32 and determines the value of the load torque, and that the conveyance time stored in step S34 is excluded from the storage target when the value of the load torque exceeds a threshold. Other functional configurations and operations are similar to the functional configurations and operations of the first embodiment, and thus detailed description thereof is omitted.

The prediction unit 126 monitors the value of the load torque at the m-th position for the sheet thickness (K). When the value of the load torque is equal to or less than a predetermined threshold (step S32: Yes), the prediction unit 126 stores the predicted value JmK obtained in step S31 as a prediction result in a storage medium such as the HDD 50 (step S33). On the other hand, when the value of the load torque exceeds the predetermined threshold (step S32: No), the obtained predicted value JmK is not stored as the prediction result (excluded from the prediction result). The prediction unit 126 excludes the latest conveyance time tm stored in step S30 by the detected information storage unit 124 from the storage target, and thus does not use the conveyance time information for subsequent prediction (step S34).

Here, the predetermined threshold is a predetermined value for determining whether or not the latest conveyance time is an abnormal value, and is a value set in advance by an experiment or the like. This coefficient may be set for each sheet thickness, may be dynamically changed according to the usage condition of the image forming apparatus 1, or the like.

As described above, according to the present embodiment, by not using the latest conveyance time information for prediction when the value of the load torque exceeds the predetermined value, it is possible to prevent a decrease in prediction accuracy of a failure timing due to an abnormal value of the conveyance time to be generated.

Although some embodiments according to the present disclosure have been described above, the above-described embodiments are presented as examples, and are not intended to limit the scope of the disclosure.

For example, the algorithm for predicting a failure timing in the prediction unit 126 of the first to fourth embodiments may use an algorithm generated by a learning effect of machine learning. Specifically, it is possible to configure so that a model (learned model) is generated by machine learning using the input value and the output value for each thickness of the sheet stored in the detected information storage unit 124 as teacher data, and the prediction unit 126 uses this model to predict the failure timing of the conveyance mechanism at the m-th position for each thickness of the sheet. Here, the input value is conveyance time information, information on the accumulative number of sheets, environmental information, load torque detection information, or the like, and the output value is information on actual failure timing (accumulative number of sheets) measured for each thickness of the sheet, or the like. The environment sensor 110 that detects the environmental information and the load torque sensors 152t, 154t, 162t, 167t, and 169t that detect the load torque function as auxiliary information detectors that detect at least one of the temperature or humidity of the environment or the load torque at the predetermined position.

The machine learning is a technique for causing a computer to acquire human-like learning capability, and refers to a technique in which a computer autonomously generates an algorithm necessary for determination of data identification or the like from learning data acquired in advance, and applies the algorithm to new data to perform prediction. Any suitable learning method is applied for machine learning, for example, any one of above-described supervised learning, unsupervised learning, semi-supervised learning, reinforcement learning, and deep learning, or a combination of two or more those learning.

FIG. 20 is a diagram schematically illustrating a functional configuration of prediction processing using a learned model. As illustrated in FIG. 20, the auxiliary information detector 500 includes an environment sensor 110 and a load torque sensor Xt. Here, the load torque sensor Xt represents all or a part of the load torque sensors 152t, 154t, 162t, 167t, and 169t described above. It is assumed that the auxiliary information detector 500 includes at least one of the environment sensor 110 or the load torque sensor Xt.

The prediction unit 126 includes a learned model 600. The learned model 600 is a model subjected to machine learning as described above. The prediction unit 126 inputs the conveyance time information and the information of the accumulative number of sheets stored in a storage medium such as the HDD 50 by the detected information storage unit 124, and at least one of the temperature or humidity of the environment detected by the auxiliary information detector 500 or the load torque at the predetermined position to the learned model 600, and predicts the failure timing of the conveyance mechanism at the predetermined position for each thickness of the sheet. In this way, by performing prediction using the learned model 600, the accuracy of prediction of the failure timing can be improved.

Each of the functions of the described embodiments may be implemented by one or more processing circuits or circuitry. The “processing circuit” in the present disclosure includes a processor programmed to execute the functions by software, such as a processor implemented by an electronic circuit, and a device such as an application-specific integrated circuit (ASIC), a digital signal processor (DSP), a field-programmable gate array (FPGA), or a known configuration such as a circuit module structure designed to execute functions described above.

Aspects of the present disclosure are, for example, as follows.

### First Aspect

An image forming apparatus includes: a sheet detector to detect a sheet conveyed by a conveyance mechanism at a predetermined position on a conveyance path; a conveyance time information acquisition unit to acquire conveyance time information indicating a conveyance time taken to convey the sheet in a predetermined section on the conveyance path, according to a detection result by the sheet detector; a sheet thickness sensor to detect sheet thickness information indicating a thickness of the sheet; a detected information storage unit to store the conveyance time information for each thickness of the sheet; and a prediction unit to predict a failure timing of the conveyance mechanism. The prediction unit predicts the failure timing of the conveyance mechanism at the predetermined position for each thickness of the sheet, using the conveyance time information stored in the detected information storage unit and an accumulative number of conveyed sheets.

### Second Aspect

In the image forming apparatus according to the first aspect, the prediction unit calculates a failure timing for the sheet having a thickness between a first thickness and a second thickness by using a first failure timing in a case of the sheet having the first thickness and a second failure timing in a case of the sheet having the second thickness.

### Third Aspect

The image forming apparatus according to the first or second aspect further includes a temperature detector to detect a temperature of an environment in which the image forming apparatus operates. The prediction unit predicts a failure timing of the conveyance mechanism at the predetermined position for each thickness of the sheet, using the conveyance time information, the accumulative number of sheets, and the temperature of the environment.

### Fourth Aspect

The image forming apparatus according to the first or second aspect further includes a humidity detector to detect humidity of an environment in which the image forming apparatus operates. The prediction unit predicts a failure timing of the conveyance mechanism at the predetermined position for each thickness of the sheet, using the conveyance time information, the accumulative number of sheets, and the humidity of the environment.

### Fifth Aspect

In the image forming apparatus according to any one of the first to fourth aspects, the prediction unit monitors a variation of a failure timing that is a prediction result for each thickness of the sheet. When a ratio of the variation of the failure timing exceeds a predetermined ratio, the prediction unit excludes the failure timing from the prediction result and does not use, for prediction, latest conveyance time information stored in the detected information storage unit.

### Sixth Aspect

The image forming apparatus according to any one of the first to fourth aspects further includes a load torque detector to detect a load torque at the predetermined position. The prediction unit monitors a value of the load torque detected by the load torque detector. When the load torque at the predetermined position exceeds a predetermined value, the prediction unit excludes the failure timing from a prediction result and does not use, for prediction, latest conveyance time information stored in the detected information storage unit.

### Seventh Aspect

The image forming apparatus according to any one of the first to sixth aspects further includes an auxiliary information detector to detect at least one of a temperature of an environment in which the image forming apparatus operates, a humidity of the environment, or a load torque at the predetermined position. The prediction unit predicts a failure timing of the conveyance mechanism at the predetermined position for each thickness of the sheet, using a model obtained by machine learning that learns, as teacher data, a relationship among the conveyance time information, the accumulative number of sheets, information detected by the auxiliary information detector, and an actual failure timing measured for each thickness of the sheet.

### Eighth Aspect

An information processing method includes a sheet detecting step of detecting a sheet conveyed by a conveyance mechanism at a predetermined position on a conveyance path, a conveyance time information acquisition step of acquiring conveyance time information indicating a conveyance time taken to convey the sheet in a predetermined section on the conveyance path according to a detection result by the sheet detecting step, a sheet thickness detecting step of detecting sheet thickness information indicating a thickness of the sheet, a detected information storage step of storing the conveyance time information for each thickness of the sheet, and a prediction step of predicting a failure timing of the conveyance mechanism. The prediction step predicts the failure timing of the conveyance mechanism at the predetermined position for each thickness of the sheet, using the conveyance time information stored in the detected information storage step and an accumulative number of conveyed sheets.

### Ninth Aspect

A program causes a computer to function as a sheet detector that detects a sheet conveyed by a conveyance mechanism at a predetermined position on a conveyance path, a conveyance time information acquisition unit that acquires conveyance time information indicating a conveyance time taken to convey the sheet in a predetermined section on the conveyance path according to a detection result by the sheet detector, a sheet thickness sensor that detects sheet thickness information indicating a thickness of the sheet, a detected information storage unit that stores the conveyance time information for each thickness of the sheet, and a prediction unit that predicts a failure timing of the conveyance mechanism. The prediction unit predicts the failure timing of the conveyance mechanism at the predetermined position for each thickness of the sheet, using the conveyance time information stored in the detected information storage unit and an accumulative number of conveyed sheets.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus, comprising:
a conveyance mechanism to convey a sheet;
a sheet sensor to detect the sheet conveyed by the conveyance mechanism at a predetermined position on a conveyance path;
a sheet thickness sensor to detect sheet thickness information indicating a thickness of the sheet; and
circuitry to:
acquire conveyance time information indicating a conveyance time taken to convey the sheet in a predetermined section on the conveyance path, according to a detection result of the sheet by the sheet sensor;
store the conveyance time information for each thickness of the sheet in a storage medium; and
predict a failure timing of the conveyance mechanism at the predetermined position for each thickness of the sheet, based on the conveyance time information stored in the storage medium and an accumulative number of sheets conveyed by the conveyance mechanism.

2. The image forming apparatus according to claim 1,
wherein the circuitry calculates a failure timing for the sheet having a thickness between a first thickness and a second thickness, based on a first failure timing in a case of the sheet having the first thickness and a second failure timing in a case of the sheet having the second thickness.

3. The image forming apparatus according to claim 1, further comprising a temperature sensor to detect a temperature of an environment in which the image forming apparatus operates,
wherein the circuitry predicts the failure timing of the conveyance mechanism at the predetermined position for each thickness of the sheet, based on the conveyance time information, the accumulative number of sheets, and the temperature of the environment.

4. The image forming apparatus according to claim 1, further comprising a humidity sensor to detect humidity of an environment in which the image forming apparatus operates,
wherein the circuitry predicts the failure timing of the conveyance mechanism at the predetermined position for each thickness of the sheet, based on the conveyance time information, the accumulative number of sheets, and the humidity of the environment.

5. The image forming apparatus according to claim 1,
wherein the circuitry monitors a variation of a failure timing that is a prediction result, for each thickness of the sheet, and
when a ratio of the variation of the failure timing exceeds a predetermined ratio, the circuitry excludes the failure timing from the prediction result and does not use, for prediction, latest conveyance time information stored in the storage medium.

6. The image forming apparatus according to claim 1, further comprising a load torque sensor to detect a load torque at the predetermined position,
wherein the circuitry monitors a value of the load torque detected by the load torque sensor, and
when the load torque at the predetermined position exceeds a predetermined value, the circuitry excludes the failure timing from a prediction result and does not use, for prediction, latest conveyance time information stored in the storage medium.

7. The image forming apparatus according to claim 1, further comprising an auxiliary information sensor to detect at least one of a temperature of an environment in which the image forming apparatus operates, a humidity of the environment, or a load torque at the predetermined position,
wherein the circuitry predicts the failure timing of the conveyance mechanism at the predetermined position for each thickness of the sheet, based on a model obtained by machine learning that learns, as teacher data, a relationship among the conveyance time information, the accumulative number of sheets, information detected by the auxiliary information sensor, and an actual failure timing measured for each thickness of the sheet.

8. An information processing method, comprising:
detecting a sheet conveyed by a conveyance mechanism at a predetermined position on a conveyance path;
acquiring conveyance time information indicating a conveyance time taken to convey the sheet in a predetermined section on the conveyance path, according to a result of detecting the sheet;
detecting sheet thickness information indicating a thickness of the sheet;
storing the conveyance time information for each thickness of the sheet; and
predicting a failure timing of the conveyance mechanism at the predetermined position for each thickness of the sheet, based on the conveyance time information stored by the storing and an accumulative number of conveyed sheets.

9. A non-transitory storage medium storing program code which, when one or more processors are executed, causes the processors to execute:
detecting a sheet conveyed by a conveyance mechanism at a predetermined position on a conveyance path;
acquiring conveyance time information indicating a conveyance time taken to convey the sheet in a predetermined section on the conveyance path according to a result of detecting the sheet;
detecting sheet thickness information indicating a thickness of the sheet;
storing the conveyance time information for each thickness of the sheet; and
predicting a failure timing of the conveyance mechanism at the predetermined position for each thickness of the sheet, based on the conveyance time information stored by the storing and an accumulative number of conveyed sheets.
